(19) United States
(12) Patent Application Publication
(10) Pub. No.: US 2008/0001865 A1
(43) Pub. Date: Jan. 3, 2008

(54) Light emitting display and driving method of the same

(75) Inventors: Ji Hun Kim, Seoul (KR); Hak Soo Kim, Seoul (KR); Jae Do Lee, Gumi-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/702,619

(22) Filed: Feb. 6, 2007

(30) Foreign Application Priority Data
Jun. 30, 2006 (KR) 10-2006-0060303

(51) Int. Cl. G09G 3/34

(52) U.S. Cl. 345/84

(57) ABSTRACT

Provided a light emitting display comprising a substrate, a pixel part located on the substrate, the pixel part comprising a plurality of sub-pixels located at the intersections of a plurality of scan lines and data lines in a matrix type format, a scan driver supplying a scan signal to the pixel part through the scan lines, a data driver converting a data signal and a pre-charge signal corresponding to the data signal into currents through the data lines so as to selectively supply the currents to the pixel part, and a controller applying control signals to the scan driver and the data driver.

This application claims priority to and the benefit of Korea Patent Application No. 10-2006-0060303, filed on Jun. 30, 2006, the entire content of which is incorporated herein by reference.

### BACKGROUND

1. Field

This document relates to a light emitting display and a driving method of the same.

2. Related Art

Among various flat panel display devices, a light emitting display device is generally advantageous of a fast response rate and low power consumption. Since a light emitting display device does not need a backlight, it can be manufactured lightweight.

In particular, an organic light emitting display device comprises an organic emission layer formed between an anode and a cathode. Thus, holes supplied from an anode and electrons supplied from a cathode are connected together within the organic emission layer to produce excitons, which are electron-hole pairs. When these excitons transit to a ground state, a certain level of energy is produced, and this energy causes the organic light emitting display device to emit light.

FIG. 1 is a driving waveform diagram of a conventional light emitting display, and FIGS. 2 and 3 are graphs illustrating the relationship between pre-charge voltages and pixel currents according to a driving method of a conventional light emitting display.

Referring to FIG. 1, a light emitting display applies a data signal in an interval, where a scan signal is applied, so as to represent a desired image. However, since parasitic capacitance is present in each sub-pixel, it is difficult to represent an accurate gray level when a data signal is input. Therefore, before a data signal is input, a pre-charge signal can be supplied in order to preliminarily charge a sub-pixel. Further, after the data signal is applied, a discharge signal is supplied to a pixel part in order to discharge a sub-pixel.

Referring to FIG. 2, ratios of pre-charge voltages to pixel currents will be examined. A graph 1 shows the relationship between pre-charge voltages and pixel currents in a case where a discharge level is 0V and a zener diode is not used in a discharge path, when a conventional light emitting display is driven, and a graph 2 shows the relationship between ideal pre-charges voltages and pixel currents.

In the related art, it can be found that a pre-charge voltage is insufficiently supplied at a low gray level where a pixel current is low, and a pre-charge voltage is excessively supplied at a high gray level where a pixel current is high, as shown in FIG. 2.

Referring to FIG. 3, ratios of pre-charge voltages to pixel currents will be examined. A graph 1 shows the relationship between pre-charge voltages and pixel currents in a case where a discharge level is a threshold value Vth and a zener diode is used in a discharge path, when a conventional light emitting display is driven, and a graph 2 shows the relationship between ideal pre-charge voltages and pixel currents.

Referring to FIG. 3, it can be found that, while a difference between an actually-applied value and an ideal value decreases at a low gray level where a pixel current is low, the difference significantly increases at a high gray level where a pixel current is high.

Therefore, as shown in FIGS. 2 and 3, an actually-required pre-charge signal is not applied to a pixel in the related art. As a result, the power consumption according to the application of pre-charge signal occupies 30% of the overall driving power consumption of a light emitting display, which means that power is unnecessarily wasted.

### SUMMARY

An advantage of the present invention is that it provides a light emitting display which can reduce power consumption and represent an accurate image according to a data signal, thereby enhancing a display quality.

According to an aspect of the invention, a light emitting display comprises a substrate, a pixel part located on the substrate, the pixel part comprising a plurality of sub-pixels located at the intersections of a plurality of scan lines and data lines in a matrix type format, a scan driver supplying a scan signal to the pixel part through the scan lines, a data driver converting a data signal and a pre-charge signal corresponding to the data signal into currents through the data lines so as to selectively supply the currents to the pixel part, and a controller applying control signals to the scan driver and the data driver.

### BRIEF DESCRIPTION OF THE DRAWINGS

FIG. 1 is a driving waveform diagram of a conventional light emitting display.

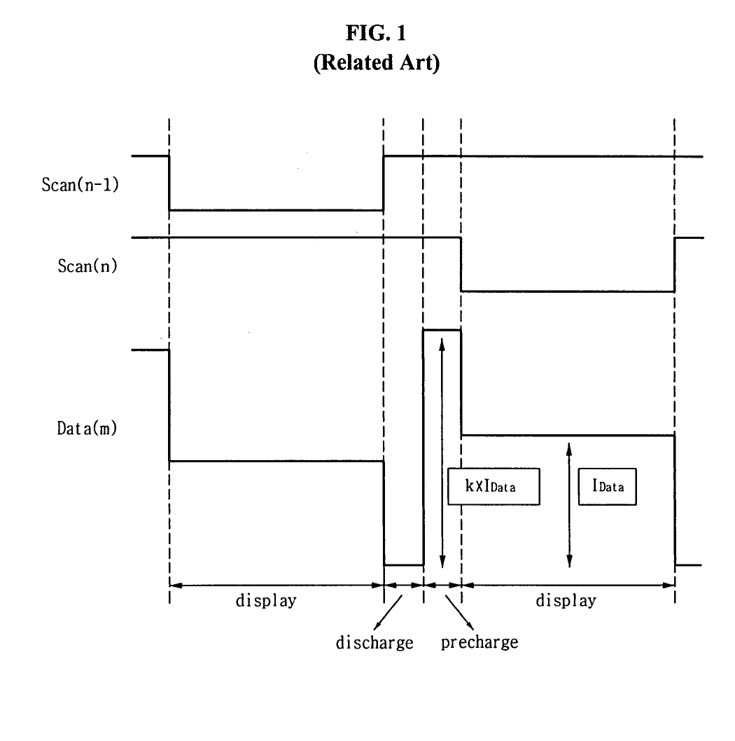

FIGS. 2 and 3 are graphs illustrating the relationship between pre-charge voltages and pixel currents according to a driving method of a conventional light emitting display.

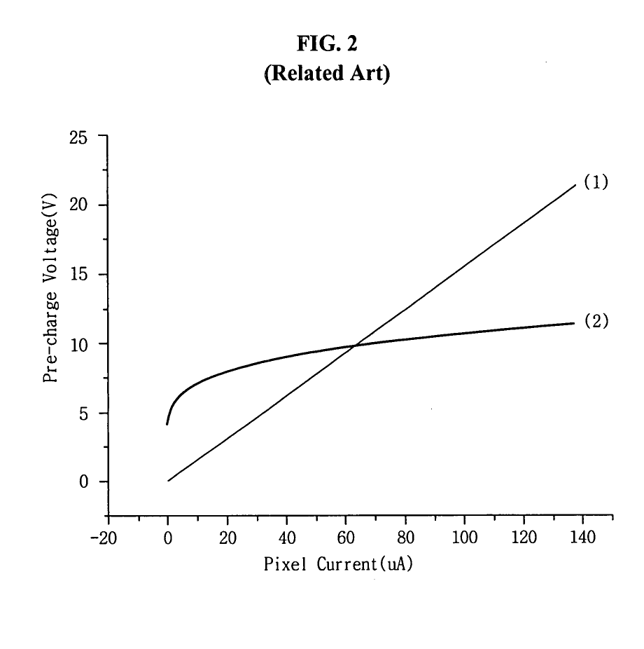

FIG. 4 is a plan view illustrating a light emitting display according to a first embodiment of the present invention.

FIG. 5 is a block diagram for explaining a driver of the light emitting display according to the first embodiment of the invention.

FIG. 6 is a waveform diagram according a driving method of the light emitting display of the first embodiment.

FIG. 7 is a graph showing the relationship between ideal pre-charge voltages and pixel currents.

FIG. 8 is a graph showing the relationship between pre-charge voltages and pixel currents according to the driving method of the light emitting display of the first embodiment.

FIG. 9 is a bock diagram for explaining a driver of a light emitting display according to a second embodiment of the invention.

FIG. 10 is a bock diagram for explaining a driver of a light emitting display according to a third embodiment of the invention.

FIG. 11 is a bock diagram for explaining a driver of a light emitting display according to a fourth embodiment of the invention.

### DETAILED DESCRIPTION

### First Embodiment

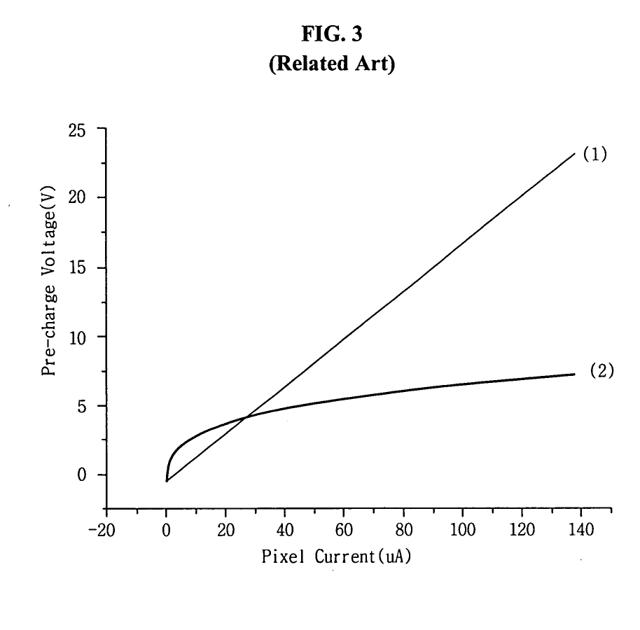

Referring to FIG. 4, a light emitting display 100 according to a first embodiment of the present invention comprises a pixel part 120 formed on a substrate 100 and a driver 140.

The pixel part 120 comprises a plurality of sub-pixels, each sub-pixel comprising an anode, a cathode, and a light emitting part interposed between two of the electrodes. Although not shown, the respective sub-pixels are positioned in a region defined by the intersections of a plurality of scan lines and data lines within the pixel part. Further, each of the sub-pixels may comprise one and more transistors and capacitors connected to the anode.

The driver 140 comprises a scan driver 145 and a data driver 150 and supplies a driving signal to the pixel part 120 through the scan lines 130A and the data lines 130B in accordance with a control signal of a controller (not shown). For convenience of description, the driver 140 is shown as one driver comprising the scan driver 145 and the data driver 150. However, the scan driver 145 and the data driver 150 may be formed independently from each other. Further, the plurality of scan drivers 145 and the plurality of data drivers 150 can compose the driver 140.

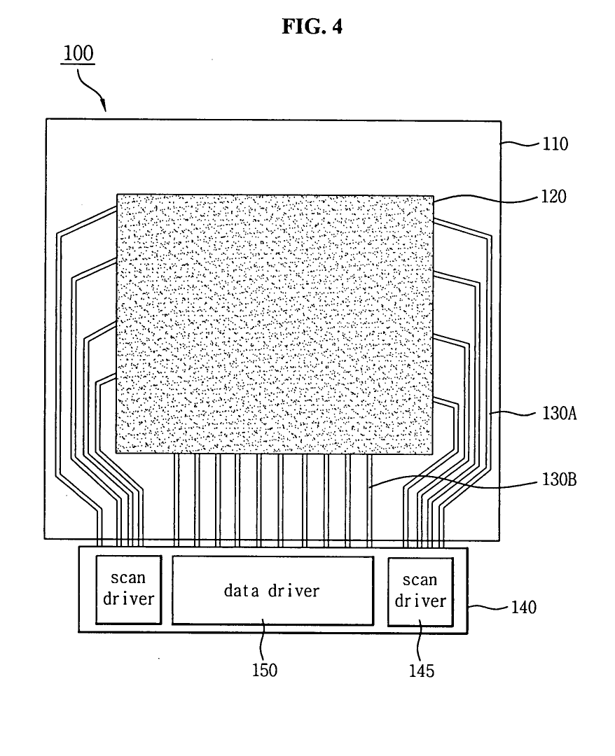

Referring to FIG. 5, the data driver 150 comprises a data output part 151, a data processing unit 152, and a converter 153.

The data output part 151 receives a digital data signal from the outside so as to deliver to the data processing unit 152. The digital data signal means a value corresponding to a gray level which is desired to be represented in the pixel part 120.

The data processing unit 152 processes the data signal received from the data output part 151 so as to generate a pre-charge signal corresponding thereto. The pre-charge signal satisfies parasitic capacitance of the pixel part so as to precisely represent a gray level according to the data signal. The pre-charge signal may be applied before the data signal is not applied to the pixel part P. The pre-charge signal can be obtained by digital-processing a data signal and thus calculating an optimal value.

The converter 153 converts the data signal or the pre-charge signal supplied from the data processing unit 152 into a current. In other words, the converter 153 converts digital signal into an analog signal.

The driver 140 may further comprise a switch part 160. The switch part 160 is connected to the controller (not shown) and the data driver 150 so as to selectively supply a data signal, a pre-charge signal, and a discharge signal to the pixel part 120. The switch part 160 may comprise a first switch SW1 located between the converter 153 and the pixel part 120 and a second switch SW2 located between a discharge path 165 and the pixel part 120. The discharge path 165 may be connected to a ground GND and further include a Zener diode.

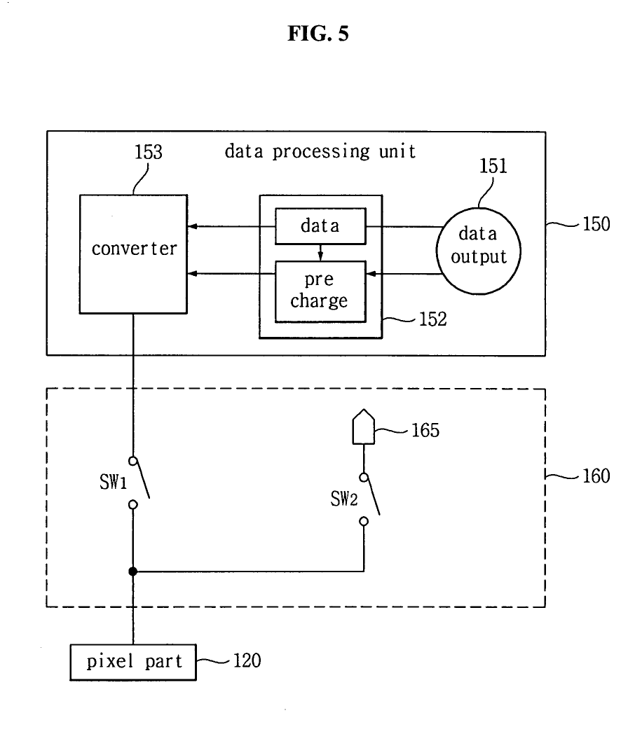

Referring to FIGS. 4 to 6, the operation of the light emitting display configured in such a manner will be described.

When a control signal from the controller are applied to the driver 140, the scan driver 145 supplies a scan signal to the pixel part 120 through the scan line 130A. The data output part 151 of the data driver 150 supplies a data signal received from the outside to the data processing unit 15. The data processing unit 152 processes the supplied data signal so as to generate a pre-charge signal corresponding to the data signal and then supplies the pre-charge signal and the data signal to the converter 153. The converter 153 converts the pre-charge signal and the data signal, which are digital signals, into currents as analog signals. Further, in accordance with a control signal of the controller, the converter 153 outputs the converted currents to the switch part 160.

When the first switch SW1 is turned on in accordance with the control signal of the controller, the pre-charge current and the data current are sequentially supplied to the pixel part 120 such that the pixel part 120 displays an image corresponding thereto. Further, when the second switch SW2 is turned on in accordance with a control signal of the controller, the pixel part 120 is connected to the discharge path 165 so as to be discharged.

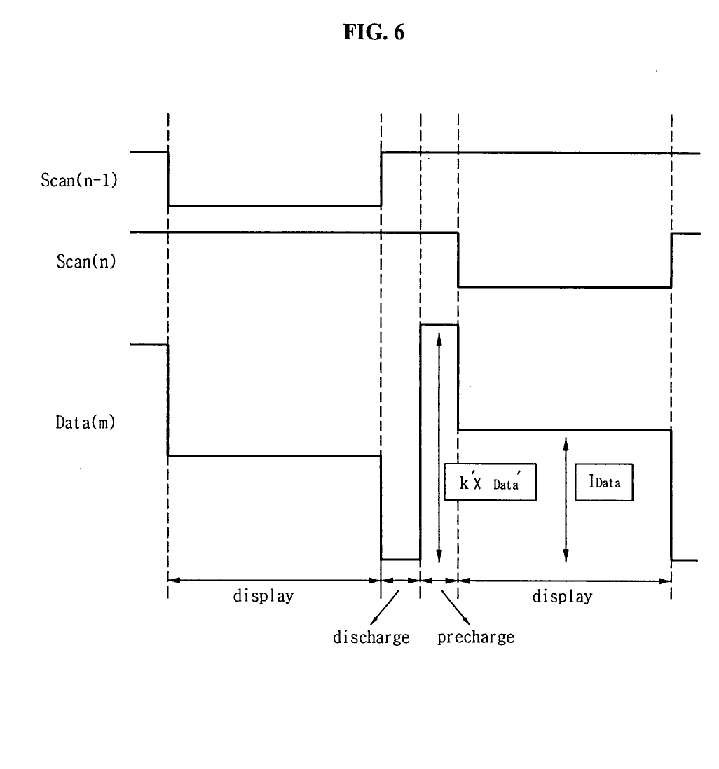

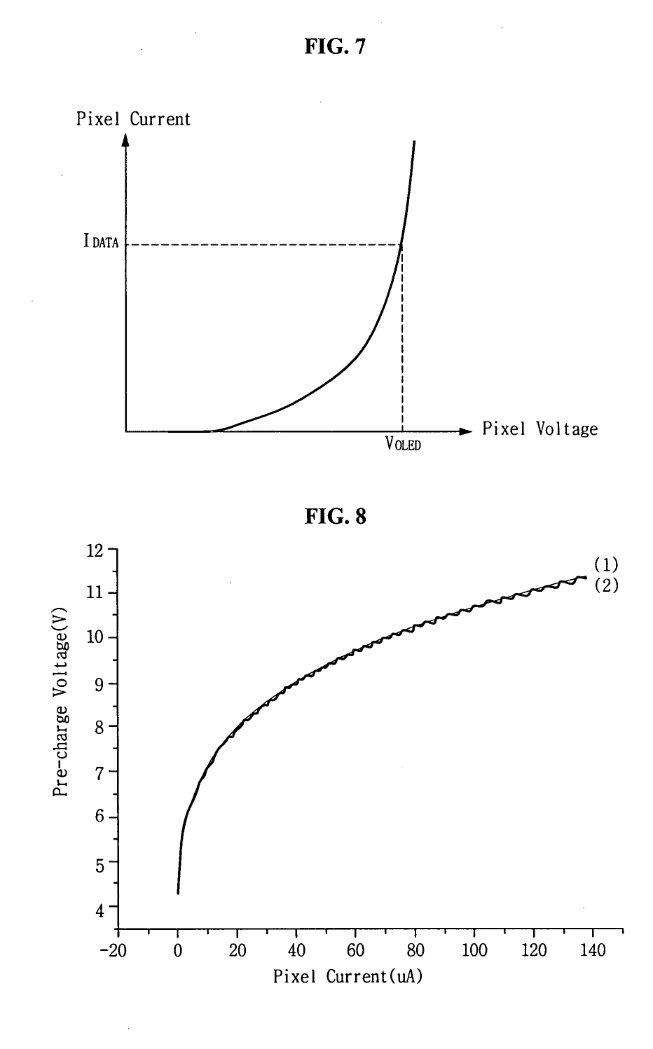

FIG. 7 is a graph showing I-V (current/voltage) characteristics of the pixel part, and FIG. 8 is a graph showing the relationship between pixel currents and pre-charge voltages according to the first embodiment of the invention.

Referring to FIG. 7, it can be found that, when a pixel current I_{DATA} flows in the pixel part, a voltage V_{OLED} applied to pixels becomes an ideal pre-charge voltage. FIG. 8 is a graph showing the relationship (1) between the pixel currents and the pre-charge voltages and the relationship (2) between the pixel voltages and the ideal pre-charge voltage in the light emitting display according to the first embodiment of the invention.

In the first embodiment of the invention, the pre-charge signal is converted into currents so as to be output to the pixel part, by which the parasitic capacitance Cap of a display part is charged so that a desired pre-charge voltage is set. Here, a formula for obtaining an ideal pre-charge current is expressed as in the following equation 1.

$${V}_{Prechar} = \frac{{I}_{Prechar} \times {t}_{Prechar}}{{C}_{DataLine}} \qquad [ Equation 1 ]$$

### V_{Prechar}: pre-charge voltage, I_{Prechar}: pre-charge current C_{DataLine}: capacitance Cap of data line, t_{Prechar}: pre-charge time

Meanwhile, when a data signal is applied to the pixel part, a pixel current I_{DATA} corresponding thereto flows in the pixel part. At this time, a voltage V_{OLED} applied to the pixel part becomes an ideal pre-charge voltage. The ideal pre-charge voltage is obtained by the following equation 2.

$${I}_{Prechar} = \frac{{V}_{OLED} \times {C}_{DataLine}}{{t}_{Prechar}} \qquad [ Equation 2 ]$$

### I_{Prechar}: pre-charge current, V_{OLED}: pixel voltage

### C_{DataLine}: capacitance Cap of data line, t_{Prechar}: pre-charge time

Referring to FIG. 8, it can be found that the light emitting display according to the first embodiment of the invention can supply the ideal pre-charge voltage to the pixel part, because the light emitting display comprises the data driver which can generate a pre-charge signal corresponding to a data signal. Therefore, a desired gray level can be represented without power being wasted.

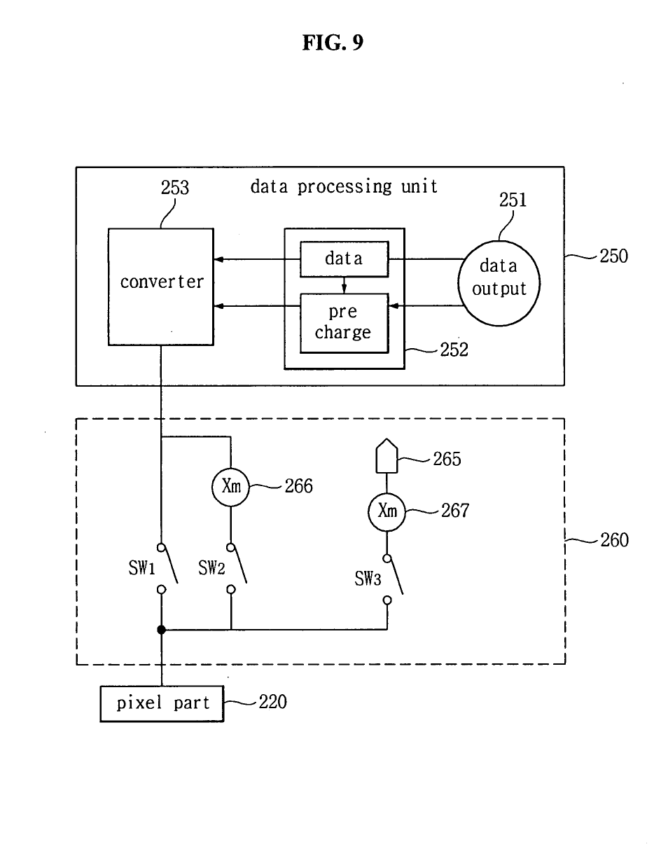

FIG. 9 is a block diagram for explaining a driver according to a second embodiment of the invention. Referring to FIG. 9, a light emitting display according to, the second embodiment of the invention comprises a data driver 250 and a switch part 260 which is connected to the driver 250 so as to supply a data signal and a pre-charge signal to a pixel part 220.

The data driver 250 comprises a data output part 251 for outputting a data signal, a data processing unit 252 for generating a pre-charge signal corresponding to the data signal, and a converter for converting a data signal and a pre-charge signal into current.

The switch part 260 comprises a first switch sw1 which is connected between the converter 253 and the pixel part so as to supply a data signal to the pixel part, a second switch sw2 which is connected between the converter 253 and the pixel part 220 so as to supply a pre-charge signal to the pixel part 220, and a third switch sw3 which is connected between a discharge path 265 and the pixel part 220 so as to discharge the pixel part. The second switch sw2 or the third switch sw3 further comprises a booster such that the pixel part can be rapidly pre-charged or discharged.

The pre-charge signal applied to the pixel part 220 by the second switch sW2 may be a value obtained by processing a data signal applied from the data output part and thus calculating an optimal data signal I_{Prechar-Data} for pre-charge. The optimal data signal I_{Prechar-Data} can be boosted k times by the booster 266 so as to be supplied to the pixel part.

I_{Prechar}=k′×I_{Prechar-Data}′ [Equation 3]

### I_{Prechar}: pre-charge current, k′: constant, I_{Prechar-Data}′: optimal data signal for pre-charge

As described above, when the optimal data signal I^{Prechar-Data} for pre-charge is boosted k times so as to be supplied to the pixel part, the pixel part can be pre-charged so as to approximate within several mVs of the ideal pre-charge voltage.

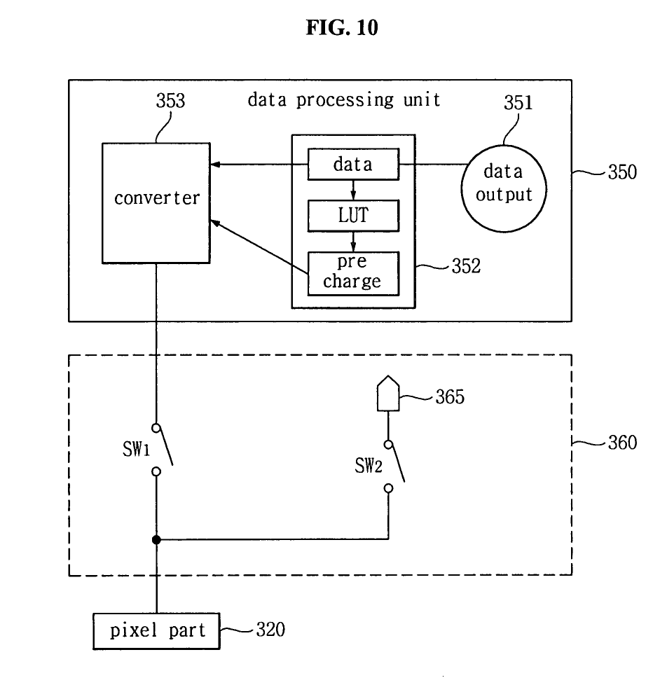

FIG. 10 is a block diagram illustrating a driver a light emitting display according to a third embodiment of the invention.

Referring to FIG. 10, the driver according to the third embodiment of the invention comprises a data driver 350 comprising a data output part 351, a data processing unit 352, and a converter 353; and a switch part 360 comprising first and second switches sw1 and sw2, the switch part 360 being connected to the data driver 350. The data processing unit 352 may comprise a look-up table LUT. Therefore, when a data signal is input from the data output part 351, the data processing unit 352 can generate a corresponding pre-charge signal by referring to the look-up table LUT.

The data processing unit 352 delivers a data signal and a pre-charge signal to the converter 353, and the converter 353 converts the data signal and the pre-charge signal into currents to supply to the pixel part 320. At this time, in accordance with a control signal of a controller, the first switch sw1 is turned on, and the time where the data signal and the pre-charge signal are applied can be also controlled. Further, when the second switch sw2 is turned on in accordance with a control signal of the controller, the pixel part 320 can be discharged through a discharge path 365.

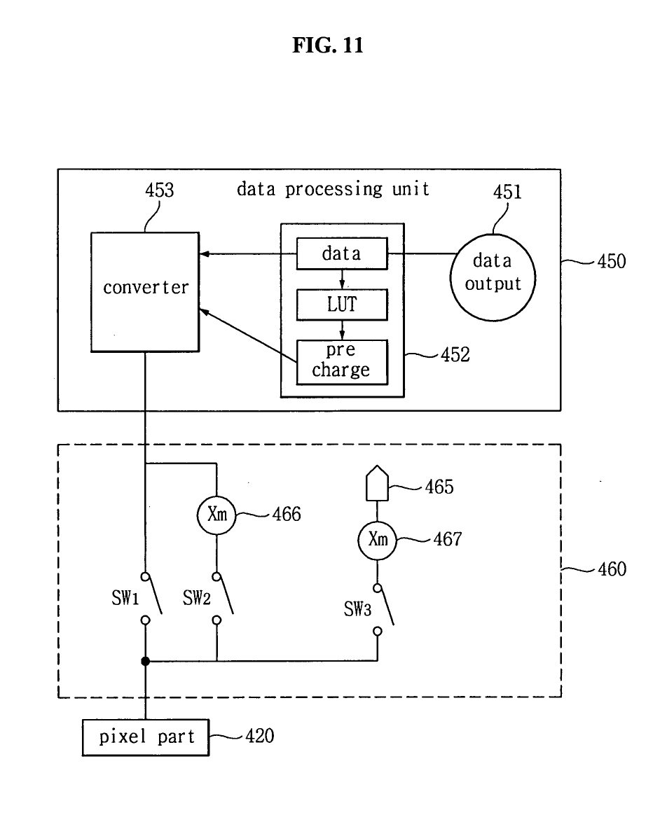

FIG. 11 is a block diagram illustrating a driver of a light emitting display according to a fourth embodiment of the invention.

Referring to FIG. 11, the driver according to the fourth embodiment of the invention comprises a data driver 450 comprising a data output part 451, a data processing unit 452, and a converter 453; and a switch part 460 comprising first to third switches sw1 to sw3, the switch part 460 being connected to the data driver 450. The data processing unit 452 may comprise a look-up table LUT. Therefore, when a data signal is input from the data output part 451, the data processing unit 452 can generate a corresponding pre-charge signal by referring to the look-up table.

The data processing unit 452 delivers a data signal and a pre-charge signal to the converter 453, and the converter 452 converts the data signal and the pre-charge signal into a current to supply to the pixel part 420. At this time, while the first switch sw1 is turned on in accordance with a control signal of a controller, the data signal can be supplied to the pixel part 420. Further, while the second switch sw2 is turned on, the pre-charge signal can be supplied to the pixel part 420. Furthermore, while the third switch sw3 is turned on, the pixel part 420 can be discharged through a discharge path 465. The second and third switches sw2 and sw3 may further comprise boosters 466 and 467, respectively. Accordingly, the pixel part 420 can be rapidly pre-charged or discharged.

According to the present invention, the data signal is processed so as to calculate an optimal pre-charge signal, and the optimal pre-charge signal is supplied to the pixel part. Therefore, the pixel part is pre-charged without power being wasted, thereby enhancing a screen quality of the light emitting display.

What is claimed is:

1. A light emitting display comprising:
a substrate;
a pixel part located on the substrate, the pixel part comprising a plurality of sub-pixels located at the intersections of a plurality of scan lines and data lines in a matrix type format;
a scan driver supplying a scan signal to the pixel part through the scan lines;
a data driver converting a data signal and a pre-charge signal corresponding to the data signal into currents through the data lines so as to selectively supply the currents to the pixel part; and
a controller applying control signals to the scan driver and the data driver.

2. The light emitting display according to claim 1,
wherein the data driver comprises a data processing unit and a converter,
the data processing unit receives a data signal so as to generate a pre-charge signal corresponding to the data signal and supplies any one of the data signal and the pre-charge signal to the converter, and
the converter converts the signal supplied from the data processing unit into a current to supply to the pixel part.

3. The light emitting display according to claim 1,
wherein the pre-charge signal is a value calculated by the data processing unit or a value set in a look-up table.

4. The light emitting display according to claim 3 further comprising a switch part,
wherein the switch part comprises a first switch which is connected between the converter and the pixel part so as to selectively supply the pre-charge signal or the data signal to the pixel part; and a second switch which is connected to the pixel part and a discharge path so as to discharge the pixel part.

5. The light emitting display according to claim 4,
wherein the controller applies a control signal to the switch part in order to turn on/off the switch part.

6. The light emitting display according to claim 3 further comprising a switch part
wherein the switch part comprises a first switch part which is connected to the converter and the pixel part so as to supply the data signal to the pixel part; a second switch part which is connected to the controller and the pixel part so as to supply the pre-charge signal to the pixel part; and a third switch which is connected to the pixel part and the discharge path so as to discharge the pixel part.

7. The light emitting display according to claim 6,
wherein the controller applies a control signal to the switch part in order to turn on/off the switch part.

8. The light emitting display according to claim 6,
wherein the switch part comprises one or more boosters, and at least one of the second and third switches is connected to the booster.

9. The light emitting display according to claim 1,
wherein the sub-pixel comprises a first electrode, a second electrode, and an organic light emitting diode comprising an organic light emitting layer interposed between the first and second electrodes.

10. The light emitting display according to claim 9,
wherein the sub-pixel further comprises a transistor and a capacitor connected to the organic light emitting diode.
